(19) United States
(12) Patent Application Publication
(10) Pub. No.: US 2025/0174925 A1
(43) Pub. Date: May 29, 2025

(54) Electrical Connector

(71) Applicant: Amphenol AssembleTech(Xiamen) Co., Ltd, Xiamen (CN)

(72) Inventors: Wenchu YANG, Xiamen (CN); Hui TANG, Xiamen (CN); Xiangui YANG, Xiamen (CN); Haitao XIONG, Xiamen (CN); Zhenxing LIU, Xiamen (CN); Hang LI, Xiamen (CN)

(73) Assignee: Amphenol AssembleTech(Xiamen) Co., Ltd, Xiamen (CN)

(21) Appl. No.: 18/956,065

(22) Filed: Nov. 22, 2024

(30) Foreign Application Priority Data
Nov. 28, 2023 (CN) 202323240926.1
Mar. 22, 2024 (CN) 202420575326.6

(51) Int. Cl. H01R 13/11; H01R 13/436; H01R 13/627

(52) U.S. Cl. CPC H01R 13/11; H01R 13/4367; H01R 13/6272

(57) ABSTRACT

An electrical connector is provided. The electrical connector includes a conductive terminal group, an insulating shell, and a cable. The conductive terminal group includes a plurality of conductive terminals, and the conductive terminal includes a conductive terminal body. The conductive terminal body includes an enclosing portion, an end of the enclosing portion includes a guiding area, and the guiding area has at least one guiding portion. The electrical connector reduces a guiding space of the guiding area, plays a pre-tightening role, prevents oblique insertion, and provides good guiding effect.

### CROSS REFERENCE TO THE RELATED APPLICATIONS

This application is based upon and claims priority to Chinese Patent Application No. 202323240926.1, filed on Nov. 28, 2023, and Chinese Patent Application No. 202420575326.6, filed on Mar. 22, 2024, the entire contents of which are incorporated herein by reference.

### TECHNICAL FIELD

The present disclosure relates to the field of electrical connectors, and in particular, to an electrical connector.

### BACKGROUND

The guiding area of a conductive terminal of an existing connector has a large guiding space and a poor guiding effect, and oblique insertion may easily occur in an insertion process. The conductive terminal is prevented from exiting from an insulating shell only through intra-slot cooperation between an abutting arm of the conductive terminal and the conductive terminal. However, when the abutting arm is damaged or deformed, the conductive terminal retreats or exits from the insulating shell.

### SUMMARY

An objective of the present disclosure is to provide an electrical connector to overcome at least one of the above disadvantages in the prior art.

In order to achieve the above objective, the present disclosure adopts the following technical solutions:

The present disclosure provides an electrical connector, including a conductive terminal group, an insulating shell, and a cable. The conductive terminal group is installed in the insulating shell. The conductive terminal group includes a plurality of conductive terminals, and an end of the cable extends into the insulating shell and is electrically connected to the conductive terminal. The conductive terminal includes a conductive terminal body. The conductive terminal body includes an enclosing portion, an end of the enclosing portion includes a guiding area, an end of the guiding area is provided with an opening, and the guiding area has at least one guiding portion.

The present disclosure further provides an electrical connector, including a conductive terminal group, an insulating shell, and a cable. The conductive terminal group is installed in the insulating shell. The conductive terminal group includes a plurality of conductive terminals, and an end of the cable extends into the insulating shell and is electrically connected to the conductive terminal. The conductive terminal includes a conductive terminal body. One end of the conductive terminal body includes an enclosing portion, an end of the enclosing portion includes a guiding area, and an end of the guiding area is provided with an opening. The conductive terminal body has a second stop portion and also includes a locking member. The locking member is inserted into the insulating shell and is disposed against and/or adjacent to an end wall of the second stop portion to keep the conductive terminal in a desired position.

The present disclosure has the following beneficial effects:

1. The guiding portion bent inward from the opening of the guiding area is disposed, which reduces a guiding space of the guiding area, plays a pre-tightening role, prevents oblique insertion, and provides good guiding effect.

2. The locking member is disposed to prevent the conductive terminal from retreating or exiting from the insulating shell.

### BRIEF DESCRIPTION OF THE DRAWINGS

FIG. 1 is a schematic diagram of a stereoscopic structure according to Embodiment 1 of the present disclosure;

FIG. 2 is a schematic diagram of a front-view structure of a conductive terminal according to Embodiment 1 of the present disclosure;

FIG. 3 is a schematic diagram of a front-view structure of a conductive terminal according to Embodiment 1 of the present disclosure;

FIG. 4 is a schematic diagram of a right-view structure of a conductive terminal according to Embodiment 1 of the present disclosure;

FIG. 5 is a schematic diagram of a top-view structure of a conductive terminal according to Embodiment 1 of the present disclosure;

FIG. 6 is a schematic diagram of an enclosing portion, a wire clamping portion, a second stop portion, a guiding area, and a first contact area according to Embodiment 1 of the present disclosure;

FIG. 7 is a schematic diagram of a sectional structure taken along A-A in FIG. 5;

FIG. 8 is a schematic diagram of a top-view structure according to Embodiment 2 of the present disclosure;

FIG. 9 is a schematic diagram of a sectional structure taken along B-B in FIG. 8;

FIG. 10 is a schematic diagram of a top-view structure according to Embodiment 3 of the present disclosure;

FIG. 11 is a schematic diagram of an enclosing portion, a wire clamping portion, a second stop portion, a guiding area, a first contact area, and a second contact area according to Embodiment 3 of the present disclosure;

FIG. 12 is a schematic diagram of a sectional structure taken along C-C in FIG. 10;

FIG. 13 is a schematic diagram of a top-view structure according to Embodiment 4 of the present disclosure;

FIG. 14 is a schematic diagram of a sectional structure taken along D-D in FIG. 13;

FIG. 15 is a schematic structural diagram of cooperation between a conductive terminal group and a locking member according to Embodiment 4 of the present disclosure;

FIG. 16 is a schematic diagram of a stereoscopic structure according to Embodiment 5 of the present disclosure;

FIG. 17 is a schematic diagram of a front-view structure according to Embodiment 5 of the present disclosure;

FIG. 18 is a schematic diagram of a left-view structure according to Embodiment 5 of the present disclosure;

FIG. 19 is a schematic diagram of a top-view structure according to Embodiment 5 of the present disclosure;

FIG. 20 is a schematic diagram of a sectional structure taken along E-E in FIG. 19;

FIG. 21 is an enlarged schematic structural diagram of F in FIG. 20;

FIG. 22 is a schematic diagram of a stereoscopic structure of a locking member according to Embodiment 5 of the present disclosure;

FIG. 23 is a schematic diagram of a left-view structure of a conductive terminal according to Embodiment 5 of the present disclosure;

FIG. 24 is a schematic diagram of a stereoscopic structure according to Embodiment 6 of the present disclosure;

FIG. 25 is a schematic diagram of a front-view structure according to Embodiment 6 of the present disclosure;

FIG. 26 is an enlarged schematic structural diagram of G in FIG. 25;

FIG. 27 is a schematic structural diagram of cooperation between two locking members according to Embodiment 6 of the present disclosure;

FIG. 28 is a schematic diagram of a top-view structure according to Embodiment 7 of the present disclosure;

FIG. 29 is a schematic diagram of a front-view structure of a locking member according to Embodiment 7 of the present disclosure;

FIG. 30 is a schematic diagram of a top-view structure according to Embodiment 7 of the present disclosure (without showing a locking member);

FIG. 31 is an enlarged schematic structural diagram of H in FIG. 30;

FIG. 32 is a schematic structural diagram of cooperation between a locking member and a conductive terminal according to Embodiment 7 of the present disclosure;

FIG. 33 is a schematic diagram of a stereoscopic structure according to Embodiment 8 of the present disclosure; and

FIG. 34 is a schematic diagram of a top-view structure according to Embodiment 8 of the present disclosure.

Reference numerals in the drawings: 1: cable; 2: insulating shell; 3: conductive terminal; 31: conductive terminal body; 311: enclosing portion; 3111: guiding area; 32: guiding portion; 3112: first contact area; 33: first clamping portion; 331: first contact point; 34: oblique arm; 35: limit portion; 31121: upper wall; 31122: lower wall; 31123: sidewall; 31124: first through hole; 36: second clamping portion; 361: second contact point; 37: third clamping portion; 371: third contact point; 3113: second contact area; 38: fourth clamping portion; 381: fourth contact point; 31125: second through hole; 39: fifth clamping portion; 391: fifth contact point; 312: positioning portion; 313: wire clamping portion; 3121: limit arm; 4: locking member; 21: first stop surface; 22: second stop surface; 310: first stop portion; 3101: second stop portion; 11: base; 12: butt portion; 121: first terminal receiving groove; 10: limit space; 111: second terminal receiving groove; 9: blocking portion; 113: channel; 114: first clamping slot; 41: first clamping portion; 42: cantilever; 115: first guiding bevel; 43: second guiding bevel; 116: third through hole; 44: second clamping portion; 45: blocking plate; 117: second clamping slot; 118: inserting hole; 119: connecting hole; 51: gap; 5: lock fastener; 6: rear gear; 7: drawstring; 8: drawstring hole.

### DETAILED DESCRIPTION OF THE EMBODIMENTS

The present disclosure will be further described with reference to the accompanying drawing and specific implementations.

### Embodiment 1

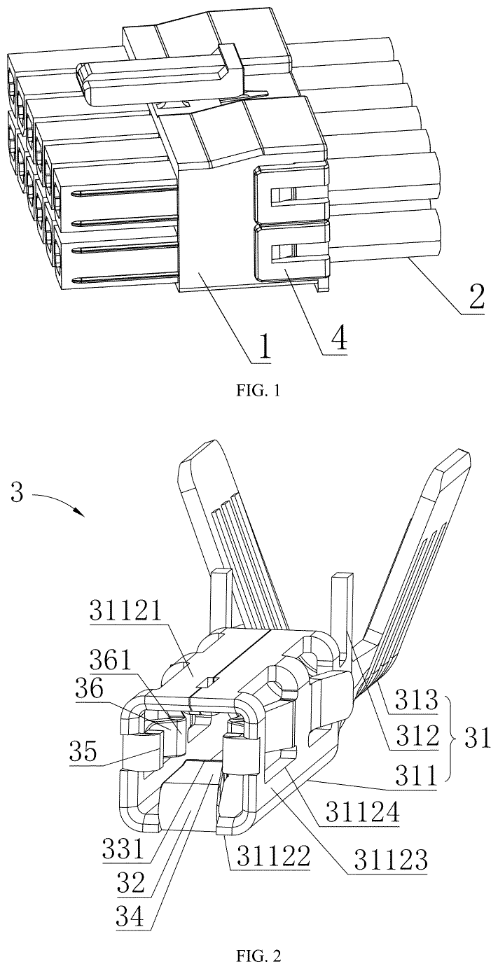

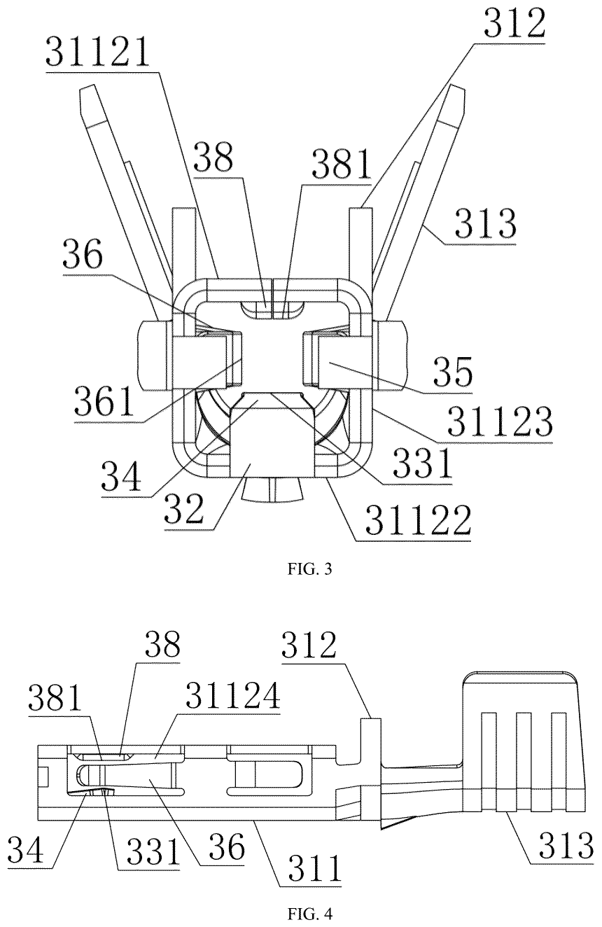

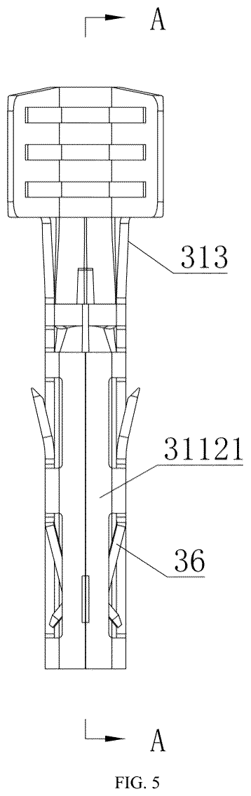

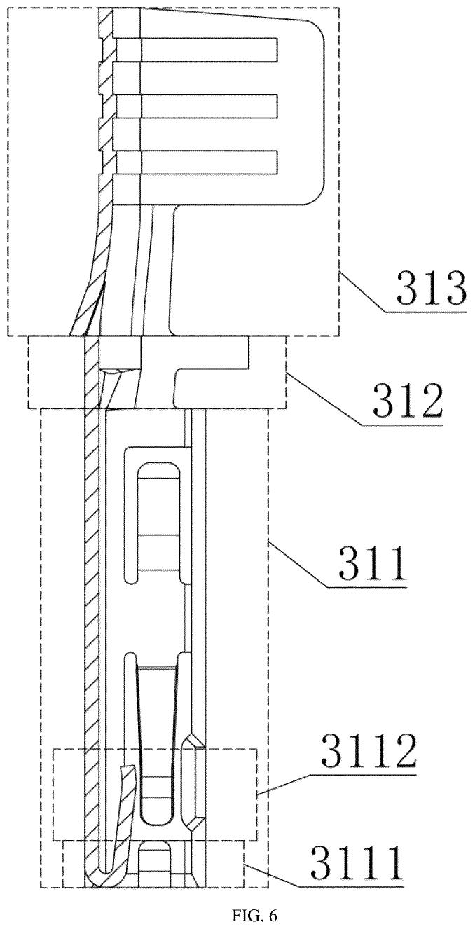

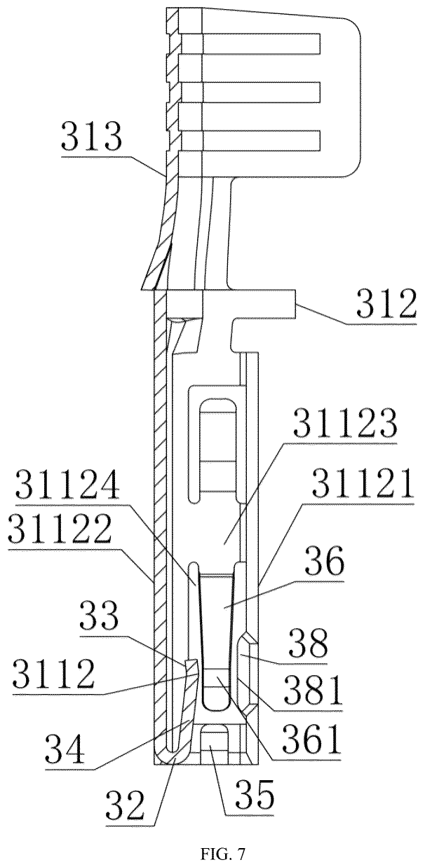

As shown in FIG. 1 to FIG. 7, an electrical connector provided in this embodiment includes a conductive terminal group, insulating shell 1, and cable 2. The conductive terminal group is installed in the insulating shell 1. The conductive terminal group includes a plurality of conductive terminals 3. A front end of the cable 2 extends into the insulating shell 1 and is electrically connected to the conductive terminal 3. The conductive terminal 3 includes conductive terminal body 31, and a front end of the conductive terminal body 31 has four clamping portions. The four clamping portions are respectively located on upper, lower, left, and right walls of the conductive terminal body 31. An inner wall of each clamping portion has one contact point, and the four contact points located on the four clamping portions are all disposed in first contact area 3112. Specifically, the conductive terminal body 31 includes enclosing portion 311, second stop portion 312, and wire clamping portion 313. A front end of the enclosing portion 311 includes guiding area 3111, and a front end of the guiding area 3111 is provided with an opening. A rear end of the guiding area 3111 is connected to the first contact area 3112. A rear end of the enclosing portion 311 is connected to the second stop portion 312, and a rear end of the second stop portion 312 is connected to the wire clamping portion 313. In this embodiment, there is guiding portion 32 bent inward from the opening of the guiding area 3111. The guiding portion 32 is provided on a lower sidewall 31123 of the guiding area 3111. The guiding portion 32 is inclined upward after being bent. A rear end of the guiding portion 32 has first clamping portion 33. The first clamping portion 33 is located in the first contact area 3112 and has one first contact point 331. The rear end of the guiding portion 32 extends backward to form the first clamping portion 33 in this embodiment. The guiding portion 32 bent inward from the opening of the guiding area 3111 is disposed, which reduces a guiding space of the guiding area 3111, plays a pre-tightening role, prevents oblique insertion, and provides a good guiding effect. In addition, combined with the first clamping portion 33, both a guiding function and a clamping function are achieved, providing an electrical connection between the first contact point 331 and a contact pin. Moreover, a contact point disposed in the first contact area 3112 can provide a better electrical connection, and reduce contact resistance and a signal loss.

The first contact point 331 is disposed on an inner side surface of the first clamping portion 33, in other words, on an upper side surface of the first clamping portion 33. Each of the first clamping portion 33 and the guiding portion 32 has oblique arm 34 that is inclined inward. In other words, the oblique arm 34 is inclined upward. Through the inclined oblique arm 34, the guiding space of the guiding area 3111 gradually decreases from front to back, and a contact space of the first contact area 3112 gradually decreases from front to back. This ensures stability of contact between the first contact point 331 and the contact pin while providing guidance.

In this embodiment, limit portion 35 bent inward is separately disposed on left and right sides of the opening of the guiding area 3111, and the limit portion 35 is located in the guiding area 3111. The left and right limit portions play a left and right limit role to prevent oblique insertion in left and right directions. Combined with the guiding portion 32, oblique insertion in up and down directions are prevented, improving overall guiding efficiency.

The enclosing portion 311 includes upper wall 31121, lower wall 31122, and left and right sidewalls 31123. The upper wall 31121 and the lower wall 31122 are connected through the left and right sidewalls 31123, and each of the left and right sidewalls 31123 is provided with first through hole 31124. An inner wall on a rear side of the first through hole 31124 has second clamping portion 36. The second clamping portion 36 is bent inward, and an inner side surface of the second clamping portion 36 has one second contact point 361. Both the first contact point 331 and the second contact point 361 in this embodiment are located in the first contact area 3112. A bottom of the upper wall 311211 has fourth clamping portion 38 protruding downward. An inner side surface of the fourth clamping portion 38 has one fourth contact point 381, in other words, the fourth contact point 381 is disposed in a lower side surface of the fourth clamping portion 38 and located in the first contact area 3112. The guiding portion 32, the first clamping portion 33, and the second clamping portion 36 in this embodiment each are of an elastic structure and form a four-contact point structure with the fourth clamping portion 38. The elastic structure has elastic and pressing force, achieving a better contact effect.

The electrical connector further includes locking member 4. The locking member 4 is separately connected to a rear end of the insulating shell 1 in a clamping manner. In addition, the locking member 4 has an abutting portion extending into the insulating shell 1 to abut against the second stop portion 312. The locking member 4 cooperates with the second stop portion 312 to better limit the conductive terminal group and improve installation stability of the conductive terminal group.

### Embodiment 2

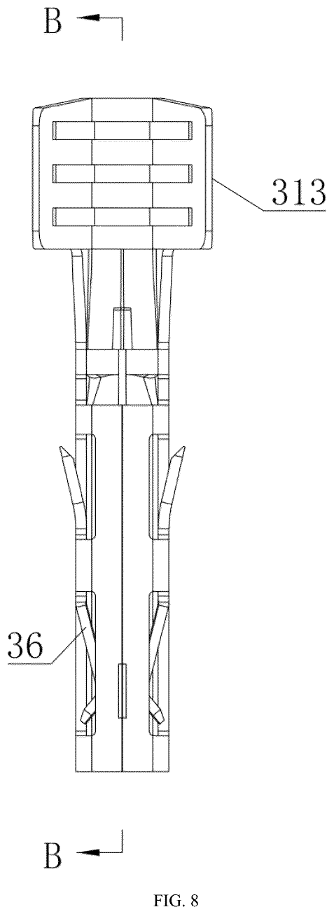

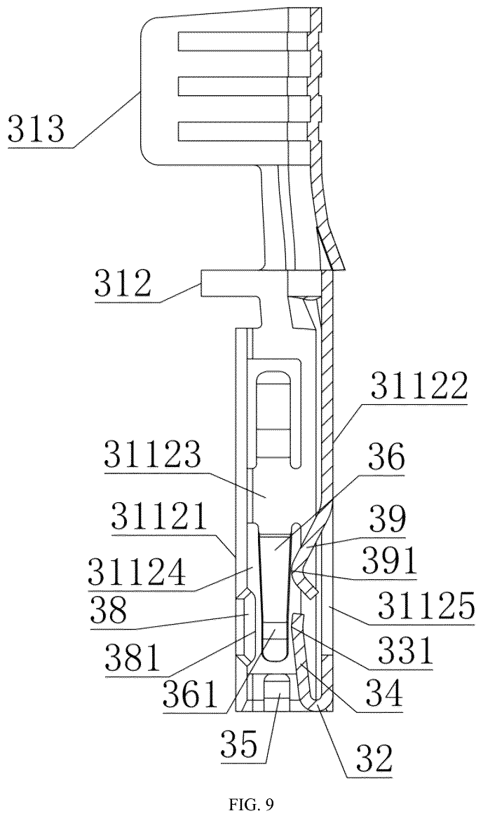

As shown in FIG. 8 and FIG. 9, this embodiment is a five-contact point structure. Specifically, the lower wall 31122 is provided with second through hole 31125, and an inner wall on a rear side of the second through hole 31125 has fifth clamping portion 39. The fifth clamping portion 39 is of the elastic structure and bent inward, and an upper side surface of the fifth clamping portion 39 has one fifth contact point 391. More contact areas are provided by adding the contact point on the lower wall 31122, so as to provide better electrical contact.

The fifth contact point 391 is located in second contact area 3113, and the first contact point 331 and the fifth contact point 391 are staggered front and back in an insertion direction. Based on the four contact points disposed in the first contact area 3112, the first contact point 331 and the fifth contact point 391 that are staggered front and back can provide better mechanical stability and reduce influence of vibration or mechanical impact on a connection, thus improving reliability of the connection.

### Embodiment 3

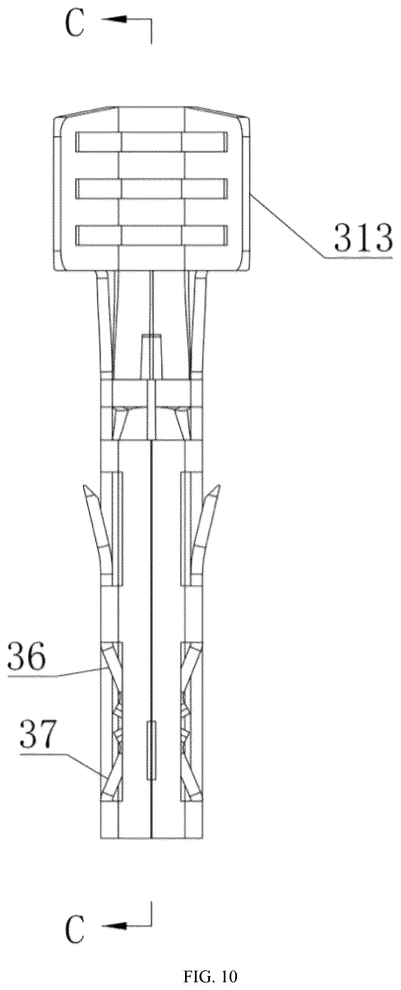

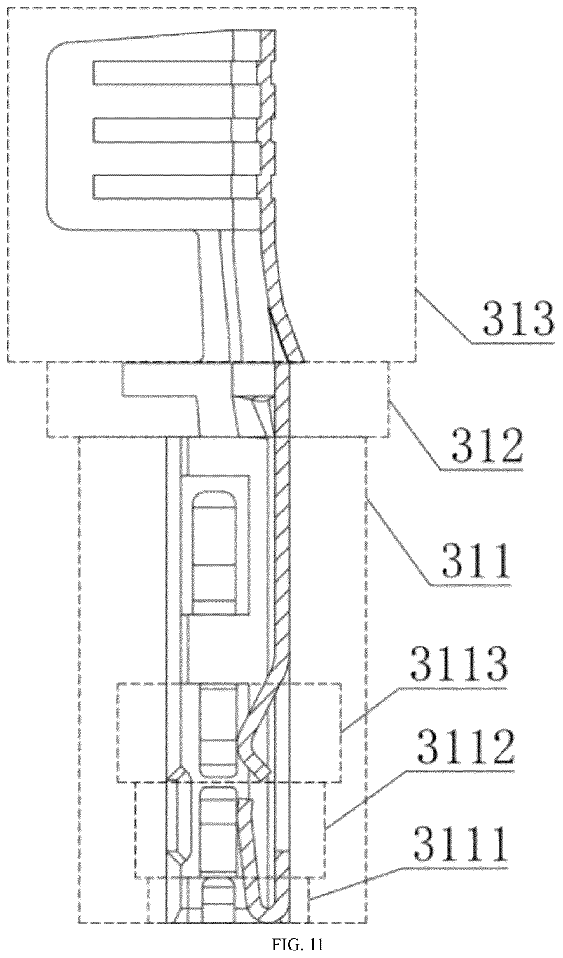

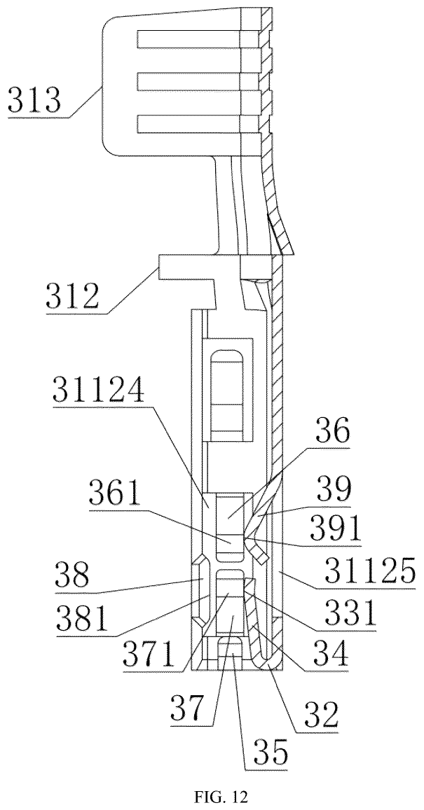

As shown in FIG. 10 to FIG. 12, this embodiment is a seven-contact point structure. Specifically, an inner wall on a front side of the first through hole 31124 has third clamping portion 37. The third clamping portion 37 is of the elastic structure and bent inward, and an inner side surface of the third clamping portion 37 has one third contact point 371. More contact areas are provided by adding the contact point on the sidewall 31123, so as to provide better electrical contact.

The third contact point 371 in this embodiment is located in the first contact area 3112, and the second contact point 361 is located in the second contact area 3113. The first contact point 331 and the second contact point 361 are staggered front and back in the insertion direction. Based on the four contact points disposed in the first contact area 3112, the first contact point 331 and the second contact point 361 that are staggered front and back, and the first contact point 331 and the fifth contact point 391 that are staggered front and back are used, and both the second contact point 361 and the fifth contact point 391 are located in the second contact area 3113, which can provide better mechanical stability.

### Embodiment 4

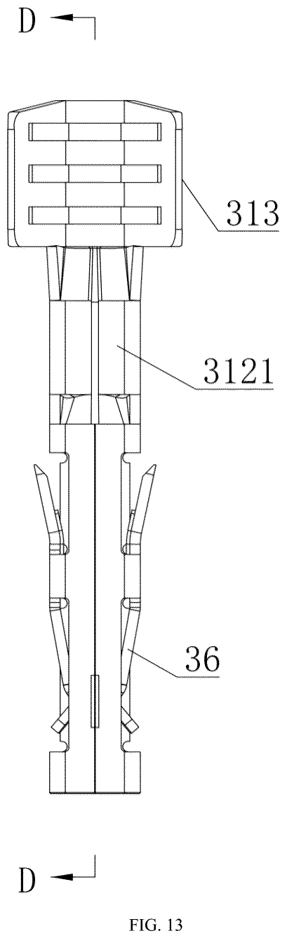

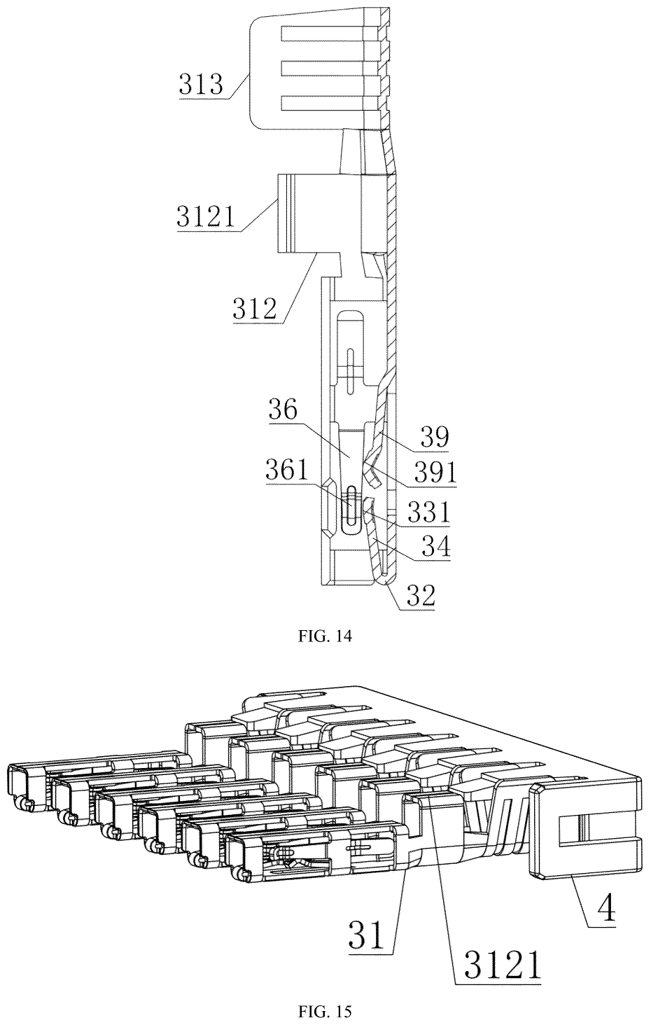

As shown in FIG. 13 to FIG. 15, this embodiment differs from Embodiment 2 as follows:

The second stop portion 312 has limit arm 3121 that extends upward and is bent inward. An inwardly bent part of the limit arm 3121 is used to abut against the abutting portion. In addition, the first contact point 331, the second contact point 361, and the fifth contact point 391 in this embodiment are of a convex hull structure, and a protruding contact point structure is adopted. In this way, each clamping portion can maintain large positive pressure on a surface of the contact pin, thereby bringing higher contact performance and further improving contact stability.

No limit portion 35 is disposed in the guiding area 3111 in this embodiment.

### Embodiment 5

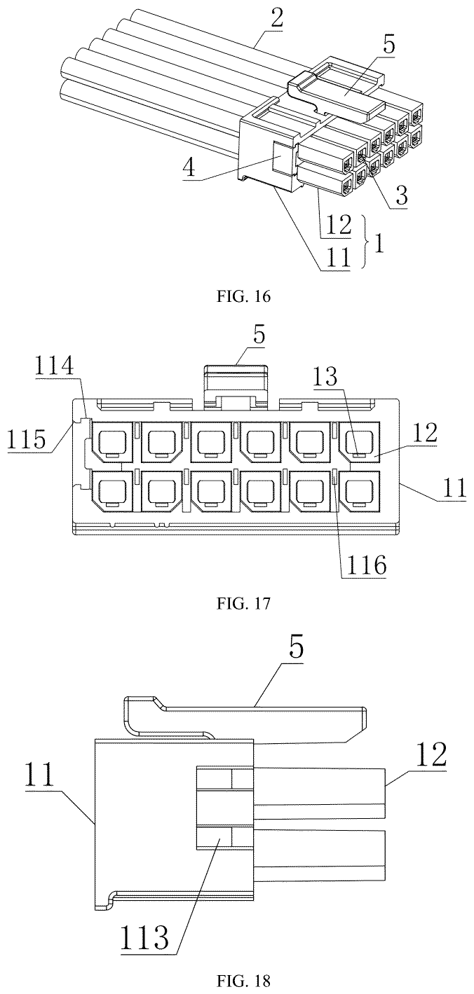

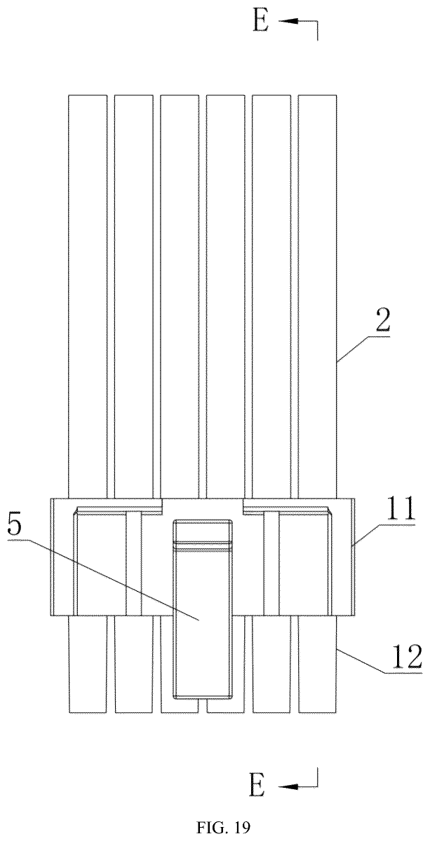

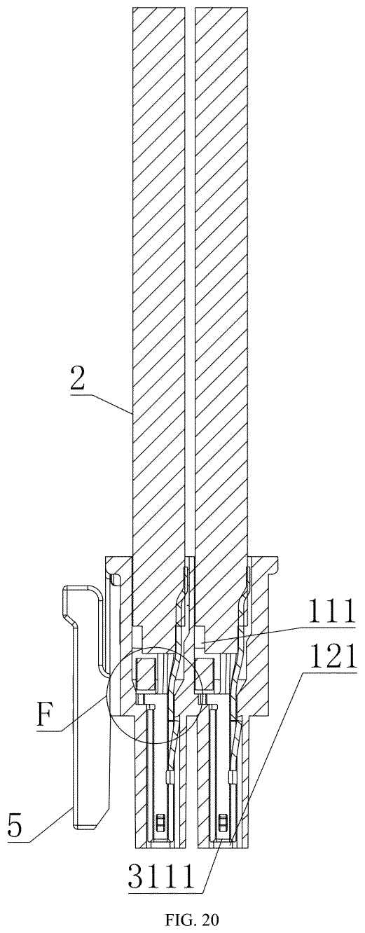

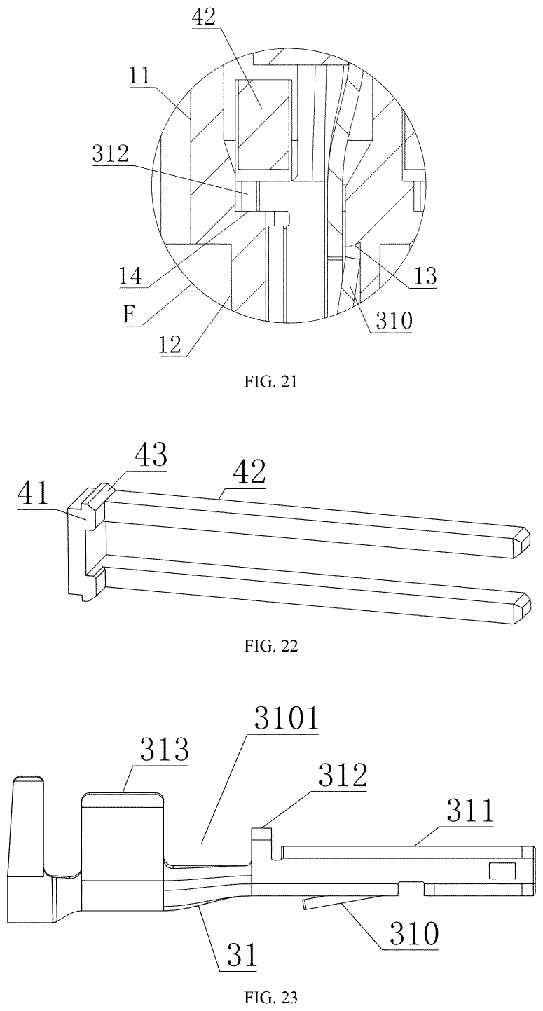

As shown in FIG. 16 to FIG. 23, an electrical connector provided in this embodiment includes a conductive terminal group, insulating shell 1, cable 2, and lock fastener 5. The conductive terminal group is installed in the insulating shell 1. The conductive terminal group includes a plurality of conductive terminals 3. A front end of the cable 2 extends into the insulating shell 1 and is electrically connected to the conductive terminal 3. The cable 2 is led out from a rear side of the insulating shell 1. A top of base 11 is provided with the lock fastener 5. The conductive terminal 3 includes conductive terminal body 31. The conductive terminal body 31 includes enclosing portion 311, a front end of the enclosing portion 311 includes guiding area 3111, and a front end of the guiding area 3111 is provided with an opening. The conductive terminal body 31 has a limit body. The electrical connector further includes locking member 4. The locking member 4 in this embodiment is inserted into the insulating shell 1 from a left side of the insulating shell 1 and adjacent to an rear-end wall of the limit body to keep the conductive terminal 3 in a desired position. The insulating shell 1 is internally provided with first stop surface 13 and second stop surface 14, and the first stop surface 13 is located on a front side of the second stop surface 14. The conductive terminal body 31 further includes first stop portion 310 and second stop portion 312. The limit body in this embodiment is the second stop portion 312. The first stop portion 310 is located on a front side of the first stop surface 13, and the second stop portion 312 abuts against a rear end of the second stop surface 14. The cooperation between the first stop portion 310 and the first stop surface 13 prevents the conductive terminal 3 from retreating. The cooperation between the second stop portion 312 and the second stop surface 14 prevents the conductive terminal 3 from advancing. When the first stop portion 310 is damaged or deformed, the locking member 4 is disposed to limit the second stop portion 312 and prevent the second stop portion 312 from retreating, thereby preventing the conductive terminal 3 from retreating or exiting from the insulating shell 1.

The insulating shell 1 includes the base 11 and a plurality butt portions 12 protruding forward from the base 11. The butt portion 12 is internally provided with first terminal receiving groove 121, and an end of the first terminal receiving groove 121 adjacent to the base 11 has the first stop surface 13. The base 11 is internally provided with a plurality of second terminal receiving grooves 111, and an end of the second terminal receiving groove 111 adjacent to the butt portion 12 has the second stop surface 14. The first terminal receiving groove 121 is connected to the second terminal receiving groove 111 to form a terminal slot for installing the conductive terminal 3. The conductive terminal 3 is installed in the terminal slot for fixation, limiting, and installation.

The base 11 is internally provided with channel 113 for the locking member 4 to pass through, and the channel 113 is located on a rear side of the second stop portion 312. After the conductive terminal 3 is installed in the terminal slot, the locking member 4 is inserted into the channel 113 to limit the conductive terminal 3 and prevent the conductive terminal 3 from retreating.

The channel 113 runs horizontally through the base 11. A left opening end of the channel 113 has first clamping slot 114 clamped with the locking member 4. The locking member 4 includes first clamping portion 41 and two cantilevers 42. The first clamping portion 41 is fixed at a left end of the cantilever 42. The first clamping portion 41 is clamped with the first clamping slot 114. The cantilever 42 is inserted into the channel 113. Through the cooperation between the first clamping portion 41 and the first clamping slot 114, the locking member 4 is fixed and installed, thereby preventing the locking member 4 from falling off. Through the cantilever 42, the second stop portion 312 is limited and prevented from retreating.

An opening end of the first clamping slot 114 has first guiding bevel 115, and a side of the first clamping portion 41 adjacent to the cantilever 42 has second guiding bevel 43. The cooperation between the first guiding bevel 115 and the second guiding bevel 43 is more conducive to inserting, installing, and fixing the locking member 4.

A maximum thickness of the first clamping portion 41 is d, and a minimum depth of the first clamping slot 114 is h, where d≤h. In this embodiment, d=h. In this way, after being installed, the locking member 4 is flush with outer sidewall 31123 of the base 11 and does not protrude from the base 11.

The butt portions 12 are spaced apart. The base 11 between adjacent butt portions 12 is provided with third through hole 116 running through the channel 113. The third through hole 116 facilitates mold demolding.

The conductive terminal body 31 further includes wire clamping portion 313. The conductive terminal body 31 is sequentially provided with the first stop portion 310, the second stop portion 312, and the wire clamping portion 313 from front to back. The first stop portion 310 is disposed in the enclosing portion 311. The wire clamping portion 313 is configured to install and fix the cable 2. Gap 3101 is disposed to provide a space for the cantilever 42 to pass through.

### Embodiment 6

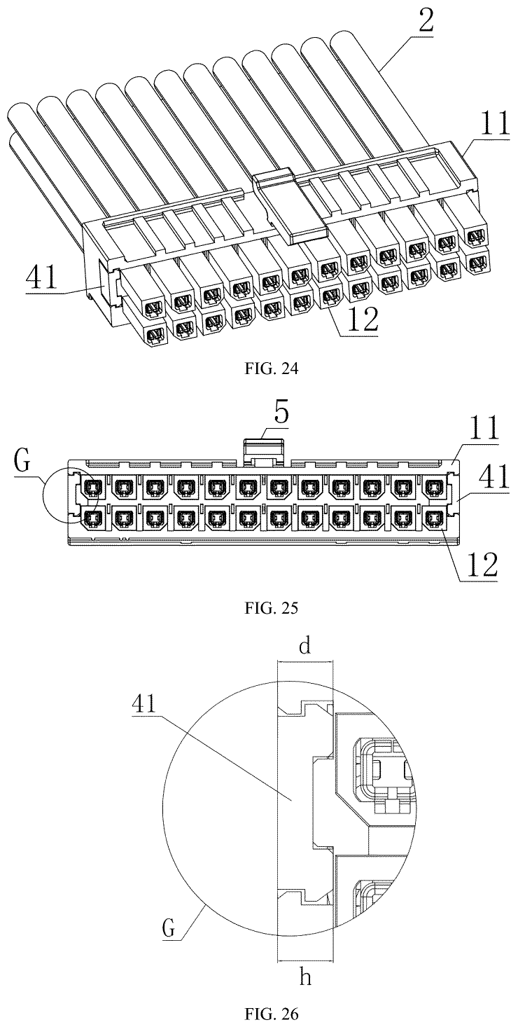

As shown in FIG. 24 to FIG. 27, this embodiment differs from Embodiment 5 as follows:

The left and right opening ends of the channel 113 both have the first clamping slot 114 that is clamped with the locking member 4. There are a total of two locking members 4. The locking members 4 on left and right sides cooperate with each other, such that all conductive terminals 3 can be limited and prevented from retreating.

### Embodiment 7

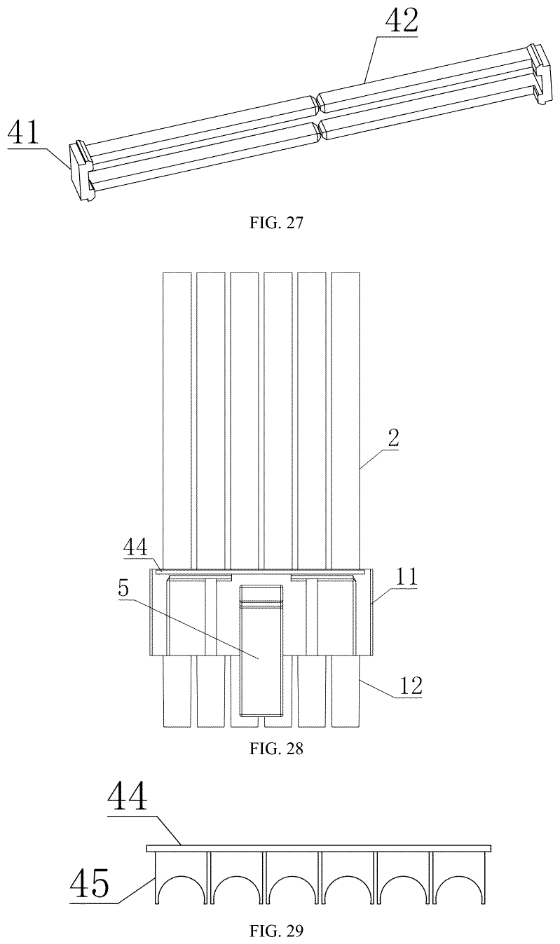

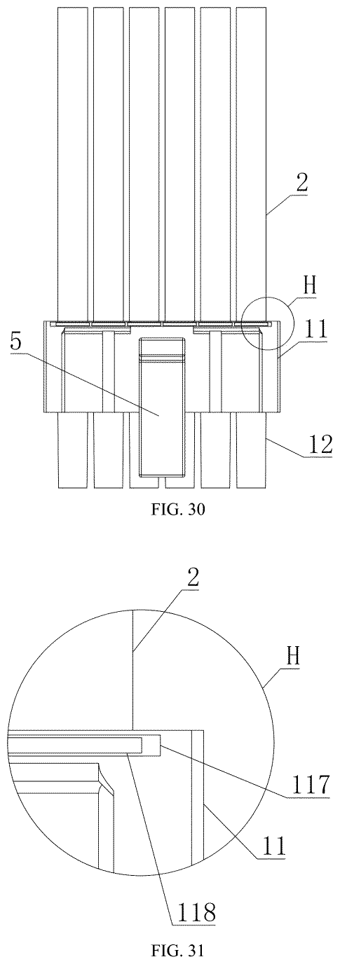

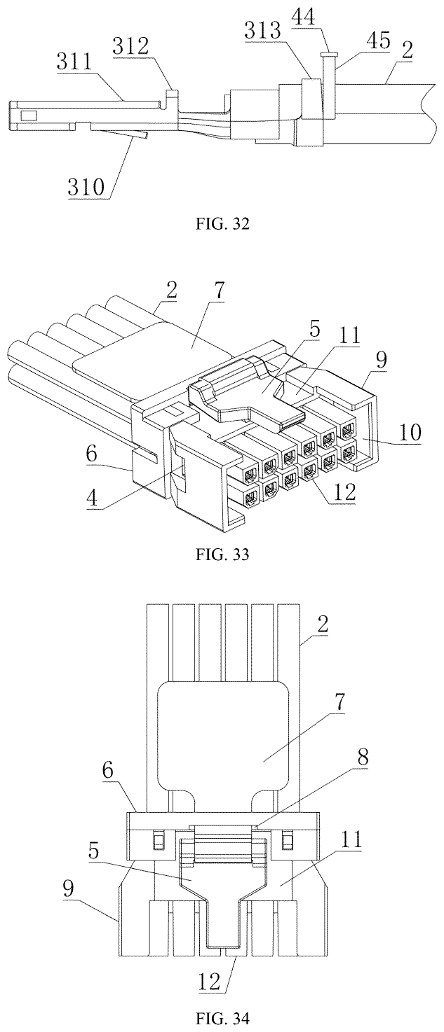

As shown in FIG. 28 to FIG. 32, this embodiment differs from Embodiment 5 as follows:

The limit body is the wire clamping portion 313. The locking member 4 is inserted into the insulating shell 1 and abuts against a rear-end wall of the wire clamping portion 313. There are upper and lower locking members 4 in total. The locking member 4 includes second clamping portion 44 and blocking plates 45. The plurality of blocking plates 45 are fixed on the second clamping portion 44. Each of the upper and lower sidewalls 31123 of the base 11 is provided with second clamping slot 117. Inserting hole 118 is provided between the second clamping slot 117 and the second terminal receiving groove 111. The second clamping portion 44 is clamped with the second clamping slot 117, and the blocking plate 45 passes through the inserting hole 118 and extends into the second terminal receiving groove 111 to abut against the rear-end wall of the wire clamping portion 313. Compared with Embodiment 5, this embodiment adopts different insertion directions to limit different portions and prevent the different portions from retreating, which can also prevent the conductive terminal 3 from retreating or exiting from the insulating shell 1.

### Embodiment 8

As shown in FIG. 33 and FIG. 34, this embodiment differs from Embodiment 5 as follows:

The electrical connector further includes rear gear 6 and drawstring 7. The rear gear 6 is detachably connected to a rear end of the base 11, and drawstring hole 8 is provided between the rear gear 6 and the base 11. The lock fastener 5 has a connecting hole 119, and the connecting hole 119 is located diagonally above the drawstring hole 8. An end of the drawstring 7 passes through the drawstring hole 8 and is connected to the connecting hole 119. The drawstring 7 is configured to perform a locking operation more conveniently.

Each of left and right sides of the base 11 is provided with blocking portion 9. The blocking portion 9 is a baffle and located on an outer side of the butt portion 12, and limit space 10 is formed between the blocking portion 9 and the butt portion 12. The limit space 10 is combined with the blocking portion 9 to prevent oblique insertion and provide protection. This effectively prevents the conductive terminal 3 from being damaged during plug and unplug or when lateral force is applied.

What is claimed is:

1. An electrical connector, comprising:
a conductive terminal group, an insulating shell, and a cable, wherein
the conductive terminal group is installed in the insulating shell, and the conductive terminal group comprises a plurality of conductive terminals;
an end of the cable extends into the insulating shell and is electrically connected to each of the plurality of conductive terminals;
each of the plurality of conductive terminals comprises a conductive terminal body, the conductive terminal body comprises an enclosing portion, an end of the enclosing portion comprises a guiding area, and a first end of the guiding area is provided with an opening; and
the guiding area has at least one guiding portion.

2. The electrical connector according to claim 1, wherein
the enclosing portion further comprises a first contact area;
a second end of the guiding area is connected to the first contact area;
the guiding portion is bent inward from the opening of the guiding area;
an end of the guiding portion has a first clamping portion, and the first clamping portion is located in the first contact area and has at least one first contact point;
the first contact point is disposed on an inner side surface of the first clamping portion; and
each of the first clamping portion and the guiding portion has an oblique arm inclined inward.

3. The electrical connector according to claim 1, wherein
at least one limit portion is bent inward from the opening of the guiding area, and the limit portion is located in the guiding area.

4. The electrical connector according to claim 2, wherein
the enclosing portion comprises an upper wall, a lower wall, and two sidewalls;
the upper wall and the lower wall are connected through the two sidewalls; and
each of the two sidewalls is provided with a first through hole, and an inner wall on a first side of the first through hole has a second clamping portion, the second clamping portion is bent inward, and an inner side surface of the second clamping portion has at least one second contact point.

5. The electrical connector according to claim 4, wherein
an inner wall on a second side of the first through hole has a third clamping portion, the third clamping portion is bent inward, and an inner side surface of the third clamping portion has at least one third contact point; and
the third contact point is located in the first contact area.

6. The electrical connector according to claim 4, wherein
an end of the first contact area away from the guiding area is connected to a second contact area;
the first contact point is located in the first contact area;
the second contact point is located in the first contact area or the second contact area;
a bottom of the upper wall has a fourth clamping portion protruding downward, and a lower side surface of the fourth clamping portion has at least one fourth contact point; and
the fourth contact point is located in the first contact area.

7. The electrical connector according to claim 4, wherein
the lower wall is provided with a second through hole, an inner wall on a side of the second through hole has a fifth clamping portion, the fifth clamping portion is bent inward, and an inner side surface of the fifth clamping portion has at least one fifth contact point;
the fifth contact point is located in a second contact area; and
the guiding portion, the first clamping portion, the second clamping portion, a third clamping portion, and the fifth clamping portion each are of an elastic structure.

8. The electrical connector according to claim 1, further comprising:
a locking member, wherein
an end of the enclosing portion away from the guiding area is connected to a second stop portion;
an end of the second stop portion away from the enclosing portion is connected to a wire clamping portion;
the second stop portion has a limit arm extending upward and bent inward; and
the locking member is integrally formed or is separately connected to an end of the insulating shell, and the locking member has an abutting portion, wherein the abutting portion extends into the insulating shell to abut against the second stop portion.

9. The electrical connector according to claim 7, wherein
at least one of the first contact point, the second contact point, a third contact point, a fourth contact point, and the fifth contact point is of a convex hull structure.

10. An electrical connector, comprising:
a conductive terminal group, an insulating shell, a cable, and a locking member, wherein
the conductive terminal group is installed in the insulating shell, and the conductive terminal group comprises a plurality of conductive terminals;
an end of the cable extends into the insulating shell and is electrically connected to each of the plurality of conductive terminals;
each of the plurality of conductive terminals comprises a conductive terminal body, the conductive terminal body comprises an enclosing portion, an end of the enclosing portion comprises a guiding area, and an end of the guiding area is provided with an opening;
the conductive terminal body has a limit body; and
the locking member is inserted into the insulating shell and disposed against and/or adjacent to an end wall of the limit body to keep each of the plurality of conductive terminals in a desired position.

11. The electrical connector according to claim 10, wherein
the cable is led out from a side of the insulating shell; and
the locking member is inserted into the insulating shell from at least one side other than the side of the insulating shell.

12. The electrical connector according to claim 10, wherein
the insulating shell is internally provided with a first stop surface and a second stop surface, and the first stop surface is located on a front side of the second stop surface; and
the conductive terminal body further comprises a first stop portion and a second stop portion, wherein the first stop portion is located on a front side of the first stop surface or abuts against the first stop surface, and the second stop portion is located on a rear side of the second stop surface or abuts against the second stop surface.

13. The electrical connector according to claim 12, wherein
the limit body is the second stop portion; and
the locking member is inserted into the insulating shell and abuts against a rear-end wall of the second stop portion or is located on a rear side of the second stop portion.

14. The electrical connector according to claim 12, wherein
the insulating shell comprises a base and a plurality of butt portions protruding forward from the base;
each of the plurality of butt portions is internally provided with a first terminal receiving groove, and an end of the first terminal receiving groove adjacent to the base has the first stop surface;
the base is internally provided with a plurality of second terminal receiving grooves, and an end of each of the plurality of second terminal receiving grooves adjacent to each of the plurality of butt portions has the second stop surface;
the first terminal receiving groove is connected to each of the plurality of second terminal receiving grooves to form a terminal slot for installing each of the plurality of conductive terminals;
the base is internally provided with a channel for the locking member to pass through, and the channel is located on a rear side of the second stop portion;
the channel runs horizontally through the base;
at least one opening end of the channel has a first clamping slot clamped with the locking member;
the locking member comprises a first clamping portion and a cantilever;
the first clamping portion is fixed at an end of the cantilever; and
the first clamping portion is clamped with the first clamping slot, and the cantilever is inserted into the channel.

15. The electrical connector according to claim 14, wherein
an opening end of the first clamping slot has a first guiding bevel, and a side of the first clamping portion adjacent to the cantilever has a second guiding bevel;
a maximum thickness of the first clamping portion is d;
a minimum depth of the first clamping slot is h;
d≤h;
the plurality of butt portions are spaced apart; and
the base between adjacent butt portions of the plurality of butt portions is each provided with a third through hole running through the channel.

16. The electrical connector according to claim 14, wherein
the conductive terminal body further comprises a wire clamping portion;
the conductive terminal body is sequentially provided with the first stop portion, the second stop portion, and the wire clamping portion from front to back; and
the first stop portion is disposed in the enclosing portion.

17. The electrical connector according to claim 16, wherein
the limit body is the wire clamping portion; and
the locking member is inserted into the insulating shell and abuts against a rear-end wall of the wire clamping portion or is located on a rear side of the wire clamping portion.

18. The electrical connector according to claim 16, wherein
the locking member comprises a second clamping portion and a plurality of blocking plates;
the plurality of blocking plates are fixed on the second clamping portion;
each of upper and lower sidewalls of the base is provided with a second clamping slot;
an inserting hole is provided between the second clamping slot and each of the plurality of second terminal receiving grooves; and
the second clamping portion is clamped with the second clamping slot, and each of the plurality of blocking plates passes through the inserting hole and extends into each of the plurality of second terminal receiving grooves to abut against a rear-end wall of the wire clamping portion or to be located on a rear side of the wire clamping portion.

19. The electrical connector according to claim 17, wherein
the limit body is the second stop portion;
the locking member is inserted into the insulating shell and abuts against a rear-end wall of the second stop portion or is located on the rear side of the second stop portion; and
a gap is disposed between the second stop portion and the wire clamping portion for the locking member to pass through.

20. The electrical connector according to claim 14, further comprising:
a lock fastener, a rear gear, and a drawstring, wherein
a top of the base is provided with the lock fastener;
the rear gear is detachably connected to a rear end of the base;
a drawstring hole is provided between the rear gear and the base;
the lock fastener has a connecting hole;
the connecting hole is located diagonally above the drawstring hole;
an end of the drawstring passes through the drawstring hole and is connected to the connecting hole; and
the base has a blocking portion, the blocking portion is located on an outer side of each of the plurality of butt portions, and a limit space is formed between the blocking portion and each of the plurality of butt portions.
